(19) United States
(12) Patent Application Publication
(10) Pub. No.: US 2007/0024626 A1
(43) Pub. Date: Feb. 1, 2007

(54) Large character set handling in limited devices

(75) Inventors: Jonathan C. Kagle, Bellevue, WA (US); Jeffrey Tzu Heng Lin, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/193,029

(22) Filed: Jul. 29, 2005

(51) Int. Cl. G06T 11/00

(52) U.S. Cl. 345/467

(57) ABSTRACT

Limited devices have memories that are typically too small to store a complete font having an extended character set. The ability to handle necessary characters can be provided by leveraging connectivity of a limited device to a PC or server without requiring significant bandwidth or substantially reducing performance of the limited device. The limited device stores portions a font (typically on a character-by-character basis) and downloads information from the server as needed to display characters for which the limited device does not have sufficient information.

### BACKGROUND

Languages with character sets having large numbers of characters can be difficult to display. For example, character sets used to represent languages such as Chinese, Japanese or Korean typically contains tens of thousands of characters, with each character typically being very complex. Representing and rendering these characters typically requires using a relatively large amount of memory.

Displaying these characters is especially difficult on limited devices (such as low-cost handheld devices) that have a relatively small amount of memory and/or limited bandwidth for receiving such information. Often, these limited devices rely on phonetic character sets such as the Japanese “Katakana” or limited word vocabularies so that large amounts of storage do not need to be added to the limited device. (This background information is not intended to identify problems that must be addressed by the claimed subject matter.)

### SUMMARY

This summary is provided to introduce a selection of concepts in a simplified form that are further described below in the Detailed Description Section. This summary is not intended to identify key features or essential features of the claimed subject matter, nor is it intended to be used as an aid in determining the scope of the claimed subject matter.

According to aspects of various described embodiments, implementations are provided for creating a mechanism to provide a fixed set of commonly-used characters within a displaying device and to provide the ability to retrieve additional characters from a PC or server when needed by the displaying device. In one aspect, a portion of a font is stored in a local memory of a device. The information that is needed to display a limited number of characters of the font can be accessed, for example, without having to use a network or other connection to obtain the needed display information. If the display information is not present in the device, the information needed for displaying the character can be received from a server. The received display information is held in a cache of the device. The received display information is used to display a character.

According to another aspect, a system for font management includes a font renderer that is configured to render characters to a display. Local memory is used to store information for rendering characters of a selected font. A font request manager is used to determine whether the local memory contains information for rendering a character of the selected font. In response to a determination by the font request manager that the local memory does not contain information for rendering a character of the selected font, a font downloader downloads from a server and causes the information for rendering the character of the selected font to be stored in the local memory.

According to yet another aspect, a system (such as a server) includes means for storing substantially all information required for displaying any requested character of a selected font. The server also includes means for receiving a request from connected devices for information required to display a requested character of the selected font and means for uploading the requested information to the connected device. The server can additionally include a data synchronizing means (such as for an email tool) that can cause font related information to be uploaded to the connected device.

Embodiments may be implemented as a computer process, a computer system (including mobile handheld computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates an exemplary system 100 for displaying characters in a limited device, according to one embodiment.

FIG. 2 illustrates an operational flow 200 for displaying characters, according to one embodiment.

FIG. 3 illustrates a general computer environment 300, which can be used to implement the techniques described herein.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Many languages have complete character sets that contain tens of thousands of characters. This would require a storage that would overwhelm the capacity of limited devices. In accordance with the present invention, all characters that are necessary to display a message can be provided by leveraging connectivity of a limited device to a PC or server without requiring significant bandwidth or substantially reducing performance of the limited device. The limited device stores portions of a font (typically on a character-by-character or code page basis) and downloads information from the server as needed to display characters for which the limited device does not have sufficient information. The downloaded information can be managed in accordance with caching policies.

The term “font” is used herein in a broad sense and comprises a number of glyphs, each of which is a graphical representation of a character. The graphical information can be in bitmap or outline form. The term “character” as used herein is used in a broad sense and can be a “letter” in a target “alphabet.” As such the “letter” may represent a sound in a target alphabet, or represent a meaning, as do ideographs and icons. In accordance with the present invention, selected information that is used to display a character within a font can be stored locally and/or fetched from a server and stored in a cache for quick access by the connected device when it needs to be rendered later.

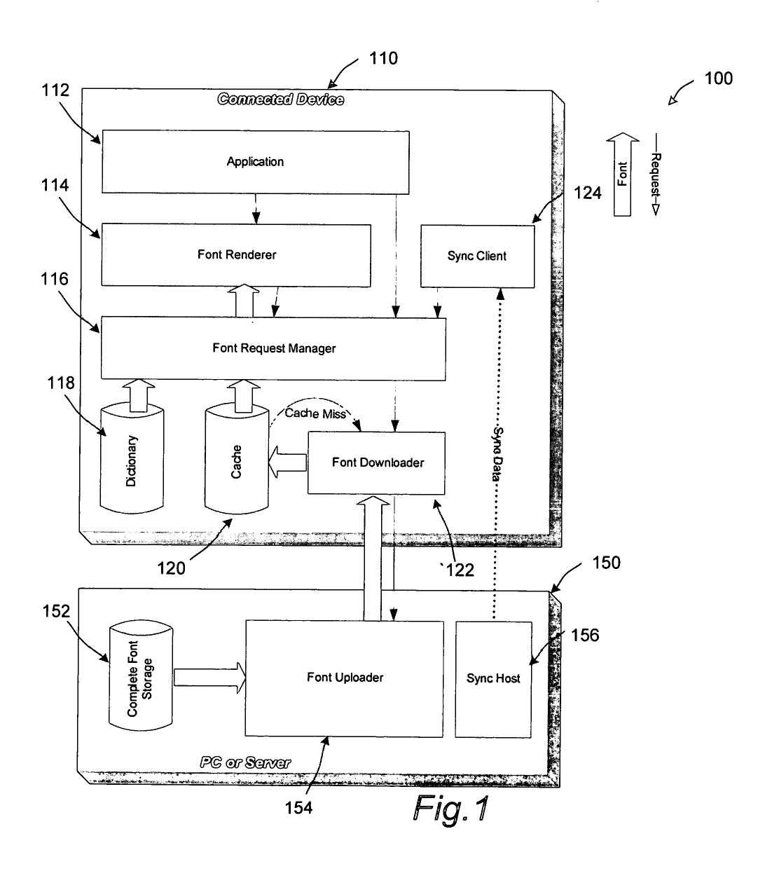

FIG. 1 illustrates an exemplary system 100 for displaying characters in a limited device, according to one embodiment. In this embodiment, system 100 comprises a connected device 110 that is coupled to a PC (personal computer) and/or server 150. Connected device 110 comprises application 112, font renderer 114, font request manager 116, dictionary 118, cache 120, font downloader 122, and sync client 124. Server 150 comprises computer font storage 152, font uploader 154, and sync host 156.

In operation, connected device 110 send requests (generally downwards, as depicted in the Figure) to server 150, which responds to the requests and sends font information to the connected device (in which the font information is generally sent in an upwards direction).

On the connected device (110) an application (112) is configured to provide user interaction, manage internal data, and provide other desired functionality (such as managing email, calendars, contacts, e-books, map directions, and the like). For example, an application can be provided that a user to check for email using this device. Application 112 typically attempts to synchronize the email data, display a user interface presenting data, and provide controls for manipulating the displayed data.

Application 112 typically causes text to be written out such that, for example, the text of an email message provides calls into a lower level component (such as font rendered 114) that draws the text. Font renderer 114 typically retrieves a requested character from a table usually stored in memory and draws it pixel-by-pixel (or by some other method) onto the display

When a letter of a typical Western font is requested, a simple 8-bit code can be used to represent a single character. For example, an ASCII encoded font provides a lookup table having 256 entries such that many Western-type fonts can be stored in a relatively small amount of character space. Even when the fonts comprise characters that are large or very complex (and perhaps having complex ornamentation), the character set comprises relatively few characters for which information needs to be stored.

In contrast, Asian-type fonts contain a much greater number of characters (which are typically encoded using a two-byte value having 65,536 possible entries. Devices that support the character set require large amounts of memory so as to be able to represent the entire character set.

Font renderer 114 can be configured to handle either (or both) rendering a character having a character code that might be addressed using one byte in the case of a Western character where a byte could fit 256 or 255 characters or rendering an Eastern character, which typically requires two bytes to encode. (More complicated and larger character sets can be imagined where even larger word sizes are needed to encode the characters.)

Font request manager 116 can be configured to provide the font information for a requested character and broker between different sources for the character images. For example, certain fonts for Western languages (or “short” character sets of other languages) can be pre-stored, as in dictionary 118. In an embodiment, requests for pre-stored characters can bypass the font request manager such that the requested information can be retrieved directly from dictionary 118 (or cache 120). Dictionary 118 and cache 120 can be stored in the same (or different) local memory devices in device 110.

When characters are requested (such as Asian characters) that are not pre-stored in dictionary 118 or in cache 120 (e.g., as in a “cache miss”), font downloader 122 can be notified. When font downloader 122 is notified that the character is not pre-stored, font downloader 122 can issue a request to font uploader 154 in server 150. Font uploader 152 typically retrieves the requested information from complete font storage 152 and returns the requested information to connected device 110 for storage in, for example, cache 120.

Accordingly, the connected device (110) can avoid a less-than-satisfactory practice of drawing a placeholder character (such as leaving a space or a dot or square) for missing characters. However, drawing an placeholder character in place of a missing character can be used until the necessary font information can be fetched, whereupon the correct character can be drawn to replace the drawn placeholder character.

Cache 120 can be operated in accordance with various caching policies, such as storing most frequently used and most recently requested characters for longer periods of time. Furthermore, the caching policies can be varied in accordance with which application is requesting the characters so as to provide optimal performance.

Synchronization of data between connected device 110 and server 150 can be requested by either (or both) connected device 110 and server 150. Likewise the flow of data for synchronization can flow in either direction.

In addition to synchronizing data between device 110 and server 150, sync client 124 (of the connected device) and/or sync host 156 (or the server) can request that character and font information can be sent to the connected device from the server in accordance with the data being synchronized.

For example, sync host 156 can scan email messages that are being synchronized and in response can select certain characters and font information to be sent to cache 120. Sending the selected characters to the connected device (110) increases the likelihood that the font information necessary to read the email messages and execute the email client will be there when the email program is invoked and email messages are opened on the connected device.

Exemplary Operational Flow

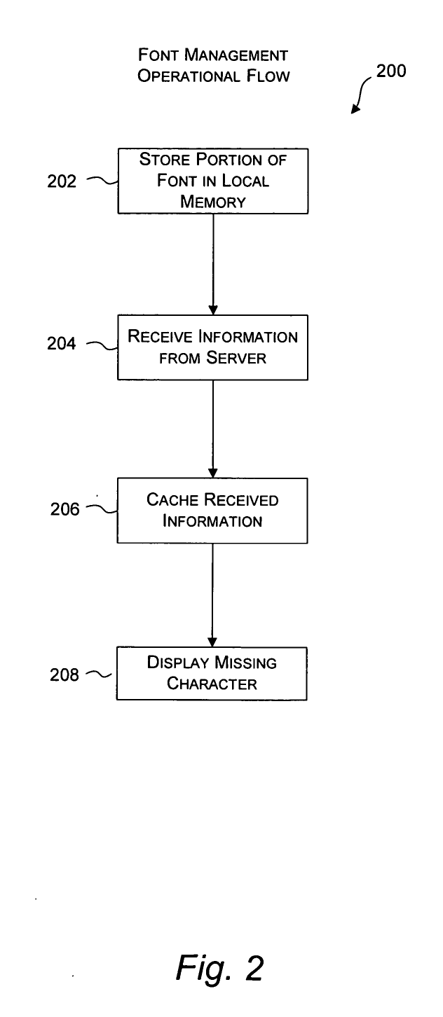

FIG. 2 illustrates an operational flow 200 for displaying characters, according to one embodiment. Operational flow 200 may be performed in any suitable computing environment. For example, operational flow 200 may be executed by an application such as user application 224 (FIG. 2) to define a form. Therefore, the description of operational flow 200 may refer to at least one of the components of FIG. 2. However, any such reference to components of FIG. 2 is for descriptive purposes only, and it is to be understood that the implementations of FIG. 2 are a non-limiting environment for operational flow 200.

At block 202, a portion of a font is stored in a local memory of a device such that information for displaying a limited number of characters can be accessed, for example, without having to use a network connection to obtain information for displaying the limited number of characters. The limited number of characters is typically substantially less than the total number of characters in the font. The local memory further comprises a cache that is configured to receive information for displaying additional characters as discussed below.

At block 204, information for displaying a missing character for which information for displaying the character has not yet been stored is received from a server. The information may be requested in response to a connection and/or a synchronization of data between the device and the server. Additionally, a selection of an application to be run (as well as an executing application) can cause the request for information to display certain characters.

At block 206, the received information for the missing character is cached in a cache of the device. The information can be cached in accordance with a predetermined cache policy. The cache policy can be determined in response to the type of application running, or the type of data being requested, for example.

At block 208, the missing character is displayed on the device display in accordance with the information for the missing character which now has been received and cached on the local device.

Illustrative Operating Environment

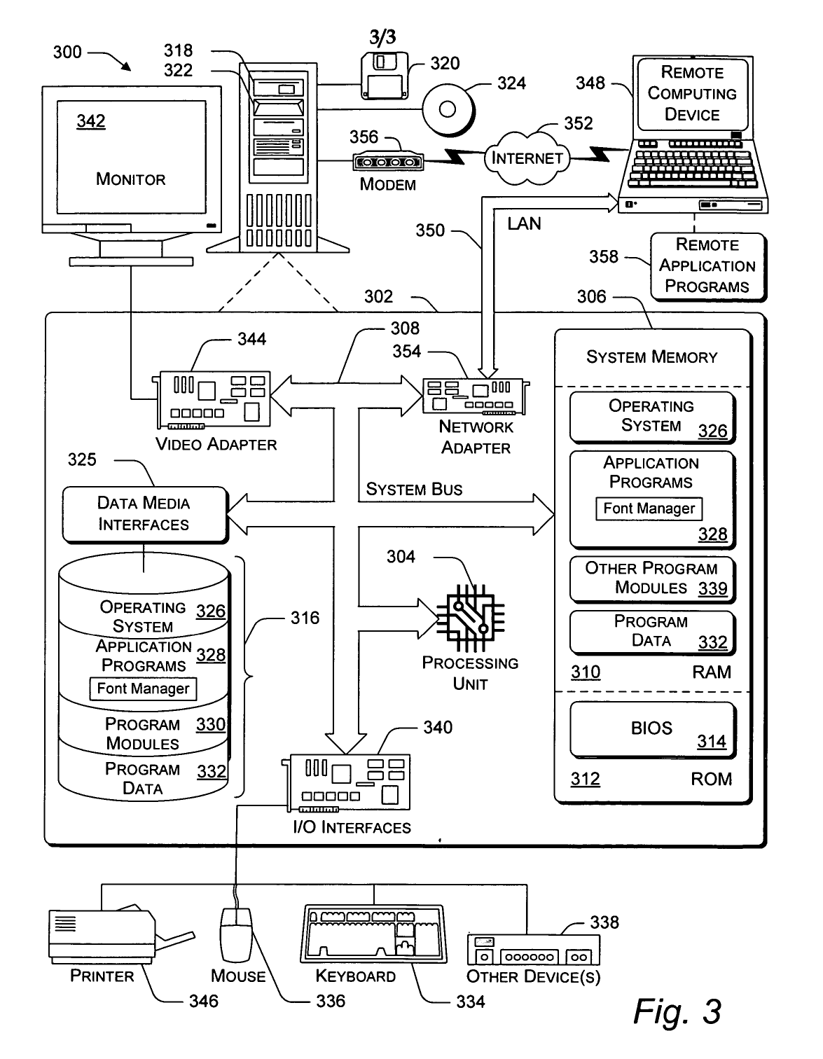

FIG. 3 illustrates a general computer environment 300, which can be used to implement the techniques described herein. The computer environment 300 is only one example of a computing environment and is not intended to suggest any limitation as to the scope of use or functionality of the computer and network architectures. Neither should the computer environment 300 be interpreted as having any dependency or requirement relating to any one or combination of components illustrated in the example computer environment 300.

Computer environment 300 includes a general-purpose computing device in the form of a computer 302. The components of computer 302 can include, but are not limited to, one or more processors or processing units 304, system memory 306, and system bus 308 that couples various system components including processor 304 to system memory 306.

System bus 308 represents one or more of any of several types of bus structures, including a memory bus or memory controller, a peripheral bus, an accelerated graphics port, and a processor or local bus using any of a variety of bus architectures. By way of example, such architectures can include various busses such as a Peripheral Component Interconnects (PCI) bus (including PCI Express), a Universal Serial Bus (USB), a Secure Digital (SD) bus, or an IEEE 1394, i.e., FireWire, bus.

Computer 302 may include a variety of computer readable media. Such media can be any available media that is accessible by computer 302 and includes both volatile and non-volatile media, removable and non-removable media.

System memory 306 includes computer readable media in the form of volatile memory, such as random access memory (RAM) 310; and/or non-volatile memory, such as read only memory (ROM) 312 or flash RAM. Basic input/output system (BIOS) 314, containing the basic routines that help to transfer information between elements within computer 302, such as during start-up, is stored in ROM 312 or flash RAM. RAM 310 typically contains data and/or program modules that are immediately accessible to and/or presently operated on by processing unit 304.

Computer 302 may also include other removable/non-removable, volatile/non-volatile computer storage media. By way of example, FIG. 3 illustrates hard disk drive 316 for reading from and writing to a non-removable, non-volatile magnetic media (not shown), magnetic disk drive 318 for reading from and writing to removable, non-volatile magnetic disk 320 (e.g., a “floppy disk”), and optical disk drive 322 for reading from and/or writing to a removable, non-volatile optical disk 324 such as a CD-ROM, DVD-ROM, or other optical media. Hard disk drive 316, magnetic disk drive 318, and optical disk drive 322 are each connected to system bus 308 by one or more data media interfaces 325. Alternatively, hard disk drive 316, magnetic disk drive 318, and optical disk drive 322 can be connected to the system bus 308 by one or more interfaces (not shown).

The disk drives and their associated computer-readable media provide non-volatile storage of computer readable instructions, data structures, program modules, and other data for computer 302. Although the example illustrates a hard disk 316, removable magnetic disk 320, and removable optical disk 324, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 316, magnetic disk 320, optical disk 324, ROM 312, and/or RAM 310, including by way of example, operating system 326, one or more application programs 328 (which can include font managers as described above), other program modules 330, and program data 332. Each of such operating system 326, one or more application programs 328, other program modules 330, and program data 332 (or some combination thereof) may implement all or part of the resident components that support the distributed file system.

A user can enter commands and information into computer 302 via input devices such as keyboard 334 and a pointing device 336 (e.g., a “mouse”). Other input devices 338 (not shown specifically) may include a microphone, joystick, game pad, satellite dish, serial port, scanner, and/or the like. These and other input devices are connected to processing unit 304 via input/output interfaces 340 that are coupled to system bus 308, but may be connected by other interface and bus structures, such as a parallel port, game port, or a universal serial bus (USB).

Monitor 342 or other type of display device can also be connected to the system bus 308 via an interface, such as video adapter 344. In addition to monitor 342, other output peripheral devices can include components such as speakers (not shown) and printer 346 which can be connected to computer 302 via I/O interfaces 340.

Computer 302 can operate in a networked environment using logical connections to one or more remote computers, such as remote computing device 348. By way of example, remote computing device 348 can be a PC, portable computer, a server, a router, a network computer, a peer device or other common network node, and the like. Remote computing device 348 is illustrated as a portable computer that can include many or all of the elements and features described herein relative to computer 302. Alternatively, computer 302 can operate in a non-networked environment as well.

Logical connections between computer 302 and remote computer 348 are depicted as a local area network (LAN) 350 and a general wide area network (WAN) 352. Such networking environments are commonplace in offices, enterprise-wide computer networks, intranets, and the Internet.

When implemented in a LAN networking environment, computer 302 is connected to local network 350 via network interface or adapter 354. When implemented in a WAN networking environment, computer 302 typically includes modem 356 or other means for establishing communications over wide network 352. Modem 356, which can be internal or external to computer 302, can be connected to system bus 308 via I/O interfaces 340 or other appropriate mechanisms. It is to be appreciated that the illustrated network connections are examples and that other means of establishing at least one communication link between computers 302 and 348 can be employed.

In a networked environment, such as that illustrated with computing environment 300, program modules depicted relative to computer 302, or portions thereof, may be stored in a remote memory storage device. By way of example, remote application programs 358 reside on a memory device of remote computer 348. For purposes of illustration, applications or programs and other executable program components such as the operating system are illustrated herein as discrete blocks, although it is recognized that such programs and components reside at various times in different storage components of computing device 302, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A computer-implemented method for displaying characters, the method comprising:
storing a portion of a font in a local memory of a device such that information for displaying a limited number of characters can be accessed, wherein the limited number of characters is less than the total number of characters in the font;
receiving from a server display information for displaying a missing character for which information for displaying the missing character has not been stored;
caching the received display information in a cache of the device; and
displaying the missing character in accordance with the cached and received display information.

2. The method of claim 1 wherein the received information is received in response to a synchronization of data between the device and the server.

3. The method of claim 1 wherein the received information is received in response to a selection of a particular application to be executed on the device.

4. The method of claim 1 wherein the received information is received in response to a request from a particular application executing on the device.

5. The method of claim 1 further comprising displaying a placeholder character for the missing character until information for displaying the missing character is received.

6. The method of claim 5 further comprising replacing the placeholder character character without replacing other characters that are not placeholder characters.

7. The method of claim 1 wherein the received information is received in response to a connection between the device and the server.

8. The method of claim 1 wherein information for displaying a range of missing characters is received for which information for displaying the range of missing characters has not been stored.

9. The method of claim 1 wherein the font comprises characters for ideographs.

10. A computer-implemented system for font management, the system comprising:
a font renderer that is configured to render characters to a display;
a local memory that is configured to store information for rendering characters of a selected font;
a font request manager that is configured to determine whether the local memory contains information for rendering a character of the selected font; and
a font downloader that is configured to in response to a determination by the font request manager that the local memory does not contain for rendering a character of the selected font, download from a server and cause to be stored in the local memory the information for rendering the character of the selected font.

11. The system of claim 10 further comprising a sync client that is configured to instruct the font downloader to download and store in the local memory the information for rendering the character of the selected font in response to synchronization of data between the device and the server.

12. The system of claim 10 further comprising an application that instructs the font renderer to display a character of the selected font.

13. The system of claim 10 wherein the local memory comprises a cache that is configured to store downloaded information for displaying characters of the selected font, and to maintain the information in the cache in accordance with a predetermined cache policy.

14. The system of claim 10 wherein the local memory contains information for displaying character in the selected font, wherein the information is not sufficient to display every character of the selected font.

15. The system of claim 10 wherein the selected font comprises Chinese characters.

16. A computer-implemented system for font management, the system comprising:
means for storing substantially all information required for displaying any requested character of a selected font;
means for receiving a request for information required to display a requested character of the selected font, wherein the request is made via a connected device; and
means for uploading the requested information to the connected device.

17. The system of claim 16 further comprising means for synchronizing of data between the connected device and the system, wherein the synchronization causes request for information required to display a requested character of the selected font to be made.

18. The system of claim 17 wherein the data synchronized by the synchronization means comprises email.

19. The system of claim 16 wherein the selected font comprises Japanese characters.
